(19) United States
(12) Patent Application Publication
(10) Pub. No.: US 2013/0208228 A1
(43) Pub. Date: Aug. 15, 2013

(54) FLOATATION DEVICE FOR GLASSES

(71) Applicant: TEET MAIDLA, Cary, NC (US)

(72) Inventor: TEET MAIDLA, Cary, NC (US)

(21) Appl. No.: 13/349,386

(22) Filed: Jan. 12, 2012

(51) Int. Cl. G02C 11/00

(52) U.S. Cl. CPC G02C 11/00
USPC 351/43

(57) ABSTRACT

The floatation device has a main body made of water proof foam material and shaped in cross section as a “U” with a length of about 1 to 2 inches. The walls are about 3 millimeters in thickness. The inside void of the “U” channel is approximately 15 millimeters by about 3 millimeters. The bottom of the U legs are connected together by a strip of highly elastic material that allows for greater variation in the temple heights, and further lends a vertical compressing force to the temple when inserted into the U channel. Normally the floatation device is inserted onto each end of the temple, ear end, and pushed to a position between the ear and the hinge of the temple.

### CROSS REFERENCES TO RELATED APPLICATIONS

See design patent application by same inventor for the floatation device, being filed.

### REFERENCE TO FEDERALLY SPONSORED RESEARCH OR DEVELOPMENT

NA

### REFERENCE TO JOINT RESEARCH AGREEMENTS

NA

### REFERENCE TO SEQUENCE LISTING

NA

### BACKGROUND OF THE INVENTION

1. Field of the Invention

The present invention relates generally to eyeglasses, and, more particularly, relates to devices for preventing their sinking in water, and, in greater particularity, relates to floatation devices for sunglasses that may be attached to temples.

2. Description of the Prior Art

Glasses are a common article of wear for many people and when these people are involved in water sport activities, there is always a chance that the glasses will fall off and into the water. Considering the high cost of glasses, especially sport or fashion glasses, a device to prevent their loss is greatly needed. Unfortunately, these same people would rather not have a conspicuous device hanging from these glasses such as cords with floats thereon as shown below in some of the issued patents. Some of the issued patents attempt to disguise the floatation means by incorporating the means into the glasses themselves, but this produces glasses that are clearly not fashionable because of additional devices, holes, patches, tubes, etc., placed thereon which can not be removed. A number of issued patents and patent applications are discussed below that highlight issues associated with this problem and possible solutions.

For example, U.S. Pat. No. 6,860,596 by Nolan has one floatation device attached to the temple. The body is half cylindrically shaped and has a longitudinal passage, offset therein, in the device that grips a straight portion of the temple. The one-piece body is made of a foam like material such as EVA. As shown in the figures, passage 34 being of rectangular shape is surrounded by a body 24 of floatation material. The attachment to the straight portions 26 of the temples is noted therein. It notes that the body 24 flexes to hold onto the straight portion 26. This requires that the body be made of a flexible material. Due to the limited design features, holding of temples having largely varying vertical heights is not shown.

U.S. Pat. No. 4,966,451 by Corral et al. shows a flotation device similar to Nolan except it is attached to the temple by bending it in half wherein a longitudinal slit opens and allows the temple to be inserted therein. It notes that large temples may require that the slit be enlarged. Additional, restraining means such as rubber bands may be used to secure the device to the temple.

U.S. Patent Application 2006/0055868 shows temples having voids therein to allow for floatation. U.S. Design Patent D572,295 to Taylor shows sport sunglasses that float. It is believed that the plastic material is lighter than water by design. U.S. Pat. No. 5,488,441 to Pomatti shows floatation material attached to the frame at the bow and at the end of the temples. A lanyard is shown attached to the ends of the temples also. U.S. Pat. No. 5,687,837 to Seiler shows a lanyard attached to the ends of the temples and having a storage pouch therein. U.S. Pat. No. 7,380,932 to Bellant shows floatation material attached to the end of the temples. A lanyard is shown attached to the ends of the temples also. U.S. Pat. Nos. 4,877,320; 5,495,303; 6,059,408; and 6,513,925 all show floatation material and devices attached to the temples or the bows. These patents are incorporated by reference.

Accordingly, there is an established need for a floatation device capable holding sport sunglasses, for example, having temples of varying heights.

### SUMMARY OF THE INVENTION

The present invention is directed at a floatation device for glasses.

Today's sunglasses can be very expensive so preventing their loss by sinking in water is important to the user. Many sunglasses have large temples and the floatation device of the present invention prevents the sinking of the sunglasses in water if dropped and one or two may be attached to the temple. Coloring of the floatation device further aids in the recovery. The temples are arms extending from the main frame and may vary in height especially in the high-end sunglasses market. The floatation device has a main body made of water proof foam material having closed cells therein and shaped in a cross section as a “U”. The bottom of the U legs are connected together by a strip of highly elastic material that allows for greater variation in the temple heights, and further lends a vertical compressing force to the temple when inserted into the channel. Normally the floatation device is inserted onto each end of the temple, ear end, and pushed to a position between the ear and the hinge of the temple. The shape of the temples in such a location is not restricted to being straight in the present invention.

An object of the present invention is to provide a floatation device for use with sports sunglasses.

It is another object of the present invention to provide a floatation device that can be formed of plastic material that is waterproof.

It is a further object of the present invention to provide a floatation device tool that has a unique wall section for holding a large high temple of sport sunglasses.

It is still a further object of the present invention to provide a floatation device that may have multiple colored areas thereon.

It is yet a further object of the present invention to provide a floatation device that is small in size, can be easily stored and is inexpensive to replace.

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 is a right side elevational view of a floatation device of the present invention;

FIG. 2A is a right side elevational view like FIG. 1, but showing one temple inserted into the floatation device causing a bottom area to be extended therefrom;

FIG. 2B is a right side cross sectional view of FIG. 1 showing one temple inserted into the floatation device causing a bottom area to be extended therefrom;

FIG. 3 is an end elevational view of the floatation device showing the interior channel therein;

FIG. 4 is a bottom plan view thereof; and

FIG. 5 is a top plan view thereof

Like reference numerals refer to like parts throughout the several views of the drawings.

### DETAILED DESCRIPTION OF THE PREFERRED EMBODIMENTS

The present invention is directed at a floatation device for use on glasses.

Many glasses have large temples and temples of varying height especially sunglasses. It should be understood that the use of the term glasses is generic to the disclosure and that the floatation device invention may be modified to fit upon any such glasses as would be known by one skilled in the art. In the preferred embodiment, the floatation device is used on glasses such as sunglasses and sport glasses. In general, the glasses have a frame with a pair of temples, i.e., arms, that are usually hinged to a front frame that holds a pair of lens. The frame may be plastic and/or metal or a combination of both. The floatation device of the present invention prevents the sinking of the sunglasses in water if dropped and one or two may be attached to the temples. The temples are arms extending from the main frame and may vary in height especially in the high-end sunglasses market.

Coloring of the floatation device further aids in the recovery and colors such a red, green, yellow or shades in between may be used. One or more colors may be applied to the surface of the tubular body 102 or the materials of the tubular body 102 may be colored.

The floatation device has a main body made of water proof foam material having closed cells. Low-density materials such as polyethylene and ethyl vinyl acetate (EVA) are suitable materials. The volume of such floatation material must be sufficient to allow the glasses to float in water. The biasing wall section is made of a highly elastic material that is fixedly attached to the bottom of the sides by conventional adhesives. The shape is not critical, but in one embodiment the sides and top are shaped in a cross section like a “U” with a horizontal length of about 1 to 2 inches. The sides are about 3 millimeters in thickness with an inside void channel being approximately 15 millimeters by about 3 millimeters. The bottom of the U legs are connected together by a strip of highly elastic material that allows for greater variation in the temple heights, and further lends a vertical compressing force to the temple when inserted into the channel. Normally the floatation device is inserted onto each end of the temple and pushed to a position between the ear and the hinge of the temple. The shape of the temples in such a location is not restricted to being straight. Clearly different models may be used for straight metal arms.

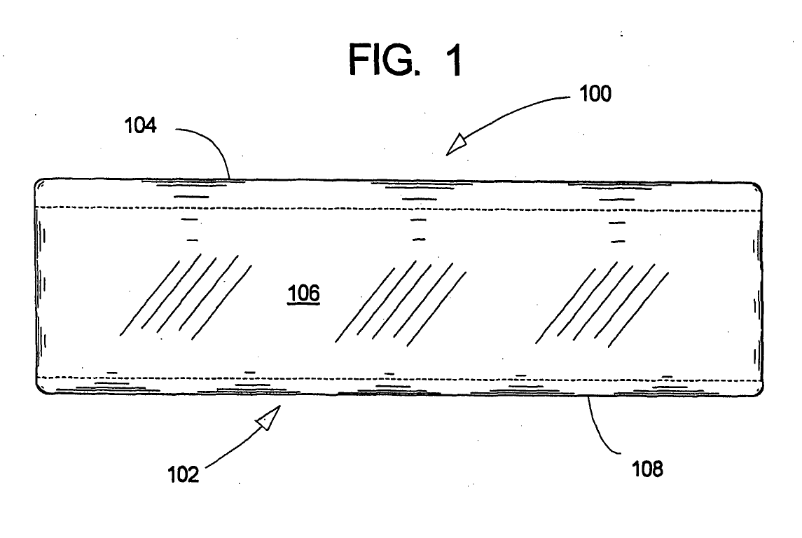

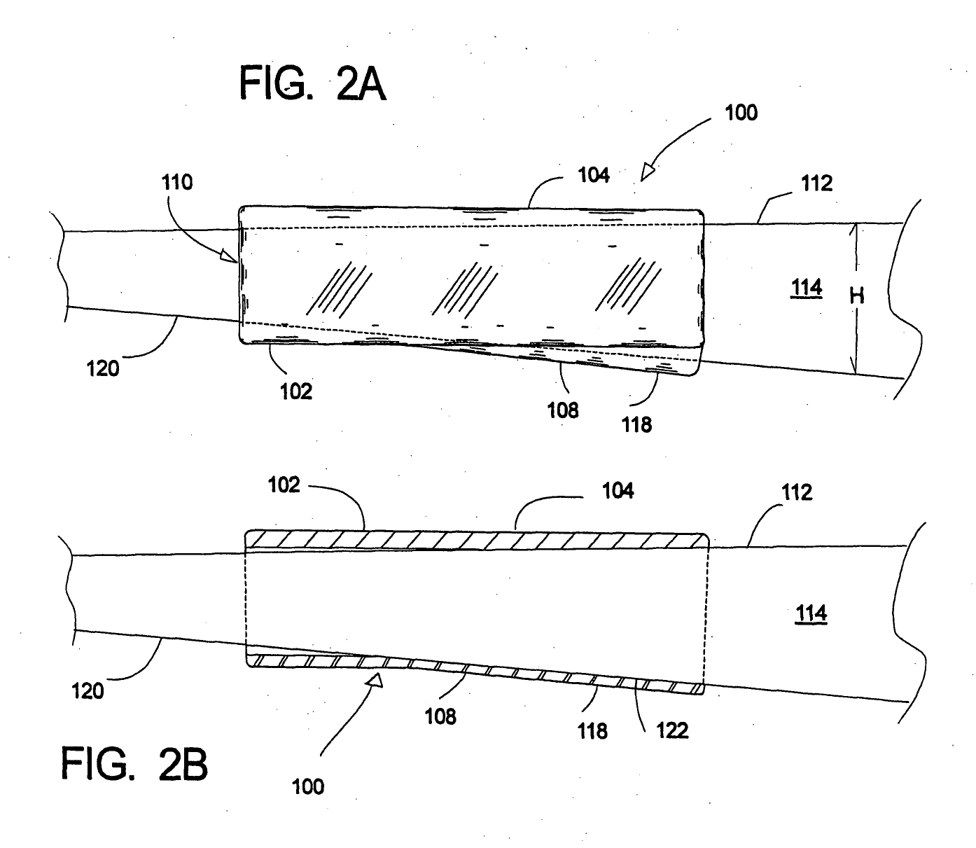

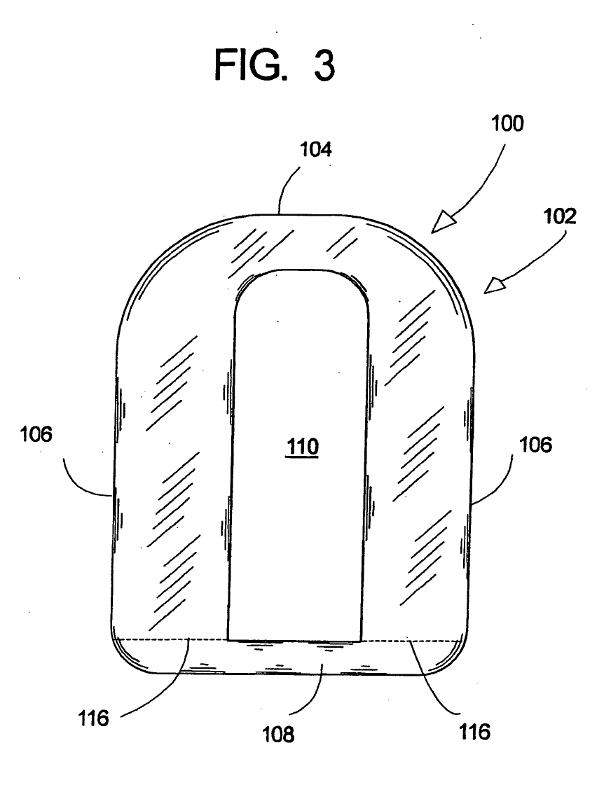

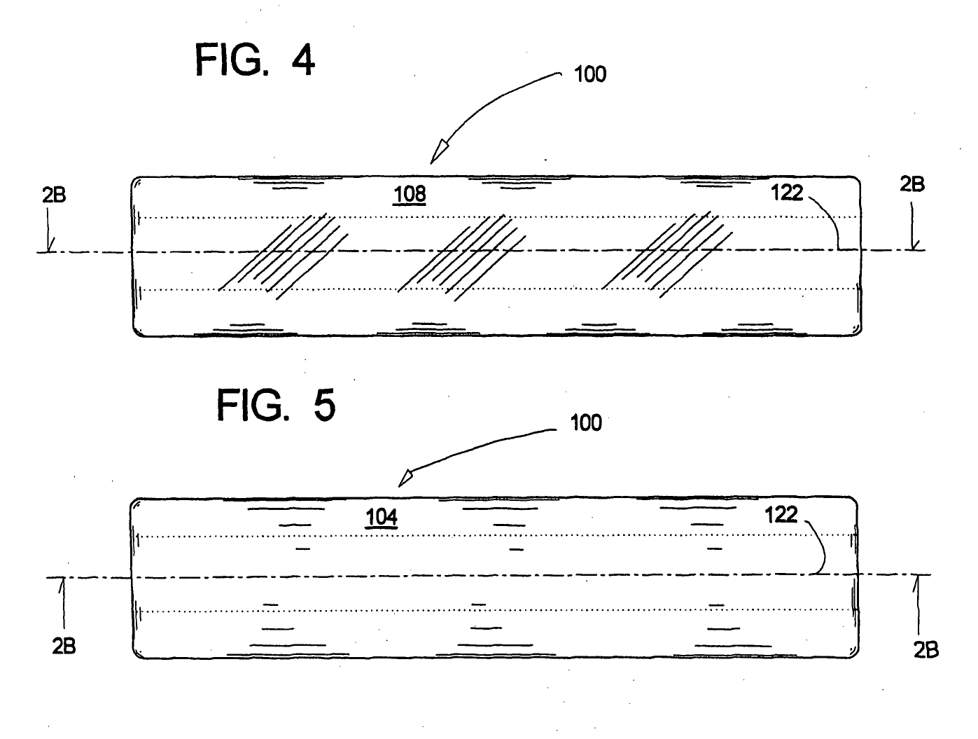

Turning to the drawings, wherein like components are designated by like reference numerals throughout the various figures, attention is initially directed to FIG. 1, that shows one floatation device 100 by side view of the present invention. The floatation device 100 has a tubular body 102 with a top 104, sides 106, only one shown, and a biasing wall section 108 and further has a hollow channel 110, FIG. 3. In the preferred embodiment, the top 104 and sides 106 are integrally formed from a single piece of plastic material. As used herein for purposes of description, the top 104 is on the top of the tubular body 102, and the biasing wall section 108, is on the bottom of the tubular body 102. In actual use, the orientation of the tubular body 102 is only critical in that a temple 112 has a cross section that is approximately rectangular and has a top and a bottom of less width than the sides 114, only one shown in FIG. 2. The biasing wall section 108 normally contacts either the top or bottom of the temple 112.

The floatation device 100 is preferably used on sunglasses with temples 112 have a varying height H, FIG. 2A. The floatation device 100 is adapted to provide a vertical holding force between said tubular body 102 and the temples 112 of the sunglasses. In particular as shown in FIG. 2A, when the temple 112 is inserted into the channel 110, the biasing wall section 108 is pushed away by flexing from the bottoms 116, FIG. 3, of the sides 106 where it is attached. A flexed portion 118 of the biasing wall 108 pushes upward upon the temple 112 into the top 104. The top 104 will also further flex to a much less degree since it is made of a foam material as noted herein. This pinching holds the temple 112 in the floatation device 100. As noted above, different models of the floatation device 100 may be used to hold different shapes of temples. These temples may have a variety of shapes from solid plastic to metal curved frames with decorative shapes therein. The upper and lower edges of the temples also need not be straight or slopping in that the biasing wall section 108 flexes.

FIG. 2B shows a cross section taken along the center line 122 of FIG.S 4 and 5 where the flexed portion 118 of biasing wall section 108 is shown partially pushed away by the bottom edge 122 of the temple 112. The channel 110 of the present invention is essentially centered in the tubular body 102 from side to side.

As shown in the Figures, the floatation device 100 biasing wall section 108 is located horizontally on the tubular body 102. It is further possible that the biasing wall section 108 is only substantially located along the horizontal length of the tubular body 102. The tubular body 102 comprises two side walls 106 and the top 104. The tubular body 102 has an end shape formed like an upside down “U”, FIG. 3. The walls 106 and top 104 may have a thickness of approximately 3 mm. The channel 110 has a width and height of approximately 3 mm by 15 mm. Different models will have different dimensions to accommodate different shaped temples. In essence, the floatation device 100 may be a universal device for different glasses including sunglasses. Clearly the temples must fit into and through the hollow channel 110 and be held securely therein by the biasing wall section 108. A smaller model will obviously hold glasses with smaller temples.

The following is only one example of construction of the floatation device 100. The tubular body 102 has a U-shape, but is made from one piece of EVA material that is approximately 1 to 2 inches long, and 30 mm wide having a thickness of about 3 mm. This piece is bend to the U-shape. The elastic material may be an elastomer material having a rectangular shape 1 to 2 inches long and about 10 mm wide. While the upper body is held in the U-shape, a waterproof (acrylic type) glue suitable for these materials is applied along the bottom legs of the U-shape and then the elastic material is applied thereon and held until set.

The floatation device 100 is inserted onto the ear end 120 of the temple 112. This is repeated for the other temple.

Since many modifications, variations, and changes in detail can be made to the described embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A floatation device for glasses, said floatation device comprising:
a tubular body having a biasing wall section of elastic material for holding temples, said tubular body being composed of a water proof foam material having sufficient floatation capacity to allow the glasses with said tubular body attached thereon to float in water.

2. The floatation device as defined in claim 1, wherein said floatation device is adapted to be attached to sunglasses temples.

3. The floatation device as defined in claim 2, wherein said sunglasses temples have a varying height, said floatation device adapted to provide a vertical holding force between said tubular body and the temples of the sunglasses.

4. The floatation device as defined in claim 3, wherein said vertical holding force is primarily provided by said biasing wall section of elastic material.

5. The floatation device as defined in claim 4 wherein said biasing wall section is located horizontally on said tubular body.

6. The floatation device as defined in claim 5 wherein said biasing wall section is substantially located along a horizontal length of said tubular body.

7. The floatation device as defined in claim 6, wherein said biasing wall section runs from one end to the other end of said tubular body.

8. The floatation device as defined in claim 1, wherein said elastic material and/or said foam material is composed of bright colors

9. The floatation device as defined in claim 1, wherein the exterior surface of said floatation device is covered by a bright colored paint to enhance visibly.

10. The floatation device as defined in claim 1, wherein said tubular body comprises:
a longitudinal wall, said longitudinal wall having a top, and two sides with said wall section of elastic material forming a bottom side.

11. The floatation device as defined in claim 10, wherein said wall section is fixedly attached to the two sides with a bonding material.

12. The floatation device as defined in claim 10, wherein said wall section is further composed of a water proof foam material.

13. The floatation device as defined in claim 10, wherein said top and said sides form a U-shaped housing having a channel between said top and said sides.

14. The floatation device as defined in claim 13, wherein one temple end, being the smaller end, is inserted into the channel wherein said biasing wall section of elastic material provides a vertical force to hold said temple therein and to prevent slipping of the temple from said floatation device.

15. A method of using a floatation device for glasses to prevent the glasses from sinking in water, said method comprising the steps of:
providing one or more floatation devices having sufficient buoyancy to be able to prevent the sinking of the glasses;
providing a floatation device having a vertically biasing force provided by an elastic material therein, the biasing force acting between the elastic material and a closed cell foam material; and
inserting one temple of the glasses into one channel in the floatation device.

16. The method as defined in claim 15, further including applying a colored material to the materials thereof.
